(19) United States
(12) Patent Application Publication
(10) Pub. No.: US 2002/0052952 A1
(43) Pub. Date: May 2, 2002

(54) Service execution method and apparatus

(76) Inventors: Atsushi Yoshida, Kawasaki (JP); Kirihiro Miyazawa, Tokyo (JP)

Correspondence Address: STAAS & HALSEY LLP, 700 11TH STREET, NW, SUITE 500, WASHINGTON, DC, 20001, US

(21) Appl. No.: 09/816,132

(22) Filed: Mar. 26, 2001

(30) Foreign Application Priority Data
Oct. 30, 2000 (JP) 2000-329952

(51) Int. Cl. G06F 15/173

(52) U.S. Cl. 709/225

(57) ABSTRACT

A service execution method for providing services to a large number of unspecified or specified users by an optimum one of a plurality of methods selected in accordance with the users' attributes, content that the users access, the terminals which the users are using to make requests, etc. A standard operation sequence for executing a service is modified in accordance with privilege information on content, information on a user using the service, and a basic operation modification rule. Content operated using the modified operation sequence is modified according to a model corresponding to a client device, and the results are provided to the user. Depending on the load on a first service execution apparatus, a second or other service execution apparatus is used. Further, content is periodically collected from content providers.

### BACKGROUND OF THE INVENTION

(1) Field of the Invention

The present invention relates to a service execution method for use in conjunction with the Internet or the like, and more particularly, to a service execution method for providing services to a large number of unspecified or specified users by an optimum one of a plurality of methods selected in accordance with the users' attributes, content services that the users access, the terminals which the users are using to make requests, etc.

(2) Description of the Related Art

Conventionally, a wide range of information services has been provided through the Internet, such as services permitting browsing, delivery or search of newspaper articles or news flashes, services permitting inquiry about the sales of or selling of various tickets, services permitting product information such as catalogs and price lists to be supplied to selling agencies or retailers, etc.

FIG. 20 illustrates a conventional information provision service using a WWW server.

Reference numeral 1001 denotes an information provider's content file, from which content of service information is supplied to a service execution apparatus 1002. The service execution apparatus 1002 is connected to client devices 1003 (users) through a network, and provides services in compliance with the clients' requests.

The service execution apparatus 1002 comprises a content file 1003 storing content used to provide services, a user information file 1004 storing user information, a WWW server 1005 for supplying content to the users' client devices 1003, and modifying means 1006 for modifying content into a form suited for the WWW server 1005.

The modifying means 1006 includes command generating/executing means 1007 for generating and executing commands, and output generating means 1008 for generating an output.

In the conventional information provision service, operations described below are performed.

First, a user sends, from his/her client device 1003, a request for service to the WWW server 1005 in the service execution apparatus 1002. On receiving the request, the service execution apparatus 1002 starts a procedure for processing the user request.

In this procedure, the command generating/executing means 1007 analyzes the request from the user, and also looks up the content file 1003 as well as the user information file 1004.

If information about the user in question is included in the user information file 1004, the command generating/executing means 1007 generates a service execution command for the user while looking up the user information, and requests the output generating means 1008 to execute the service.

The output generating means 1008 sends execution results generated thereby to the WWW server 1005, which then transmits the resulting content to the user's client device 1003.

Content of information to be provided as service is transferred from the information provider 1001 to the service execution apparatus 1002 by various methods using ftp (File Transfer Protocol) on the Internet, electronic mail, or a physical medium which is delivered from hand to hand, and is stored in the content file 1003.

The conventional information provision service described above is associated with problems stated below.

A first problem is that an increase in the number of users will make the throughput of the service execution apparatus 1002 insufficient to meet needs. In the conventional service execution apparatus 1002, no measures are taken to cope with the problem.

A second problem is concerned with the efficiency of generating commands for processing requests of individual users.

In the service execution apparatus 1002 shown in FIG. 20, the command generating/executing means 1007 generates a command from the very beginning in response to every service request from a user, by using the user request as well as the user information (if stored in the user information file 1004), so that the command generation efficiency is not high.

Specifically, even in cases where most users have only to be provided with a uniform and standard service, as in the provision of information on newspaper articles, a command is generated for each user, without being used in common or shared among the users, and thus the command generation efficiency is low.

To solve the problem of low efficiency, services may previously be classified into services for general users and individualized services for specified users, and the aforementioned uniform and standard service may be provided as a service for general users. This, however, leads to complicated configuration of the service execution apparatus itself.

A third problem arises from the fact that the service execution apparatus 1002 is not configured to provide services to different types of client devices 1003. In order for various types of client devices 1003 to be provided with services, the client devices 1003 themselves need to be configured in conformity with the service execution apparatus 1002, but this leads to complicated configuration of the client devices.

Especially, as a form of providing services through the Internet, attention needs to be directed to the provision of information not only to personal computers but also to a diversity of client devices such as portable telephones, PDAS, family game machines and information technology-based household electric appliances, and such demand is expected to sharply increase in future.

A fourth problem lies in that the procedure for transferring information from the information provider 1001, who provides services, to the service execution apparatus 1002 is complicated, and this lowers the information updating efficiency and as a consequence makes it difficult to ensure the quality of information.

Specifically, in cases where a medium storing information is sent by mail or information is transmitted by electronic mail, the information provider must store the information in the medium or modify the information to be attached as a file to electronic mail. Also, the information supplier as a recipient must take the trouble to relocate the information from the received medium or electronic mail to a corresponding directory of the information providing server.

Even in the case of transferring information by using ftp, the information provider is required to select information that needs to be newly transmitted and also to perform an information transfer operation as an ftp client.

Accordingly, in order to avoid a mistake being made by human, an administrator fully responsible for the transfer of information for providing services must be posted on both the information supplier (service execution apparatus 1002) side and the information provider (1001) side. With increase in the number of information providers, however, the load on the information supplier increases.

### SUMMARY OF THE INVENTION

An object of the present invention is to provide a service execution method capable of providing services to a large number of unspecified or specified users by an optimum one of a plurality of methods selected in accordance with the users' attributes, content that the users access, the terminals which the users are using to make requests, etc.

Another object of the present invention is to provide a service execution apparatus capable of providing services to a large number of unspecified or specified users by an optimum one of a plurality of methods selected in accordance with the users' attributes, content that the users access, the terminals which the users are using to make requests, etc.

To achieve the first object, there is provided a service execution method which comprises receiving a service request from a user, obtaining load information of a server device corresponding to the service request from a device for managing the load information of the server device, and requesting another server device to process the service request if it is judged that a load on the server device included in the load information is higher than a predetermined value.

To achieve the first object, there is also provided a service execution method which comprises extracting privilege information from a content privilege information file storing privilege information on content, extracting information on a user from a user information file storing information about users who use services, extracting a standard operation sequence from a basic service database storing standard operation sequences for executing the services, extracting a modification rule from a basic operation modification rule database storing rules for modifying the standard operation sequences, and modifying the standard operation sequence by applying the modification rule thereto with reference to the content privilege information and the user information, to obtain a operation sequence matching the user.

Further, to achieve the first object, there is provided a service execution method which comprises obtaining an attribute of a client device used by a user, from first storing means storing client devices and attributes thereof in association with each other, obtaining a model corresponding to the client device used by the user with use of the attribute of the client device of the user, from second storing means storing attributes of client devices and models corresponding thereto, and modifying a service obtained in compliance with a request from the user according to the model and sending the modified service to the user.

To achieve the first object, there is further provided a service execution method which comprises periodically acquiring from an information provider content which is used to provide a service, and updating the acquired content and storing the updated content in a content storage device.

To achieve the second object, there is provided a service execution apparatus which comprises means for receiving a service request from a user, means for obtaining load information of a server device for processing the service request, means for determining whether or not a load on the server device included in the load information is higher than a predetermined value, and means for requesting another server device to process the service request if it is judged that the load on the server device is higher than the predetermined value.

To achieve the second object, there is also provided a service execution apparatus comprising a content privilege information extracting device for extracting privilege information from a content privilege information file storing privilege information on content, a user information extracting device for extracting information on a user from a user information file storing information about users who use services, a basic service database for storing standard operation sequences for executing the services, a basic operation modification rule database for storing rules for modifying the standard operation sequences, and a user-oriented operation generating device for modifying a standard operation sequence for executing a service stored in the basic service database, by applying thereto a rule obtained from the basic operation modification rule database with reference to the content privilege information supplied from the content privilege information extracting device and the user information supplied from the user information extracting device.

Also, to achieve the second object, there is provided a service execution apparatus which comprises first storing means for storing client devices and attributes thereof in association with each other, first acquiring means responsive to use of a client device by a user, for acquiring from the first storing means an attribute corresponding to the client device used by the user, second storing means for storing models corresponding to the client devices in association with the respective attributes of the client devices, second acquiring means for acquiring from the second storing means a model corresponding to the client device of the user, and a result generating device for obtaining the attribute of the client device from the first acquiring means and the model corresponding to the client device from the second acquiring means, and modifying a service obtained in compliance with a request from the user so as to match the client device.

To achieve the second object, there is further provided a service execution apparatus comprising means for periodically acquiring from an information provider content which is used to provide a service, and content storing means for updating the acquired content and storing the updated content.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic diagram showing an exemplary configuration of a system to which an embodiment of the present invention is applied;

FIG. 2 shows a group of devices included in a content extracting device;

FIG. 3 is a diagram illustrating a configuration of an input/output management device;

FIG. 4 shows an example of a queue;

FIG. 5 is a diagram illustrating how content synchronization is achieved between service execution apparatuses;

FIG. 6 is a flowchart illustrating operation of the input/output management device;

FIG. 7 is a diagram illustrating a configuration of the content extracting device;

FIG. 8 shows an example of user information stored in a user information file;

FIG. 9 shows an example of content privilege information stored in a content privilege information file;

FIG. 10 shows an example of a modification rule for modifying a basic service operation;

FIG. 11 shows an example of generation of a user-oriented operation;

FIG. 12 is a flowchart illustrating operation of the content extracting device;

FIG. 13 is a diagram illustrating a configuration of a content modifying device;

FIG. 14 shows an example of client device information;

FIG. 15 is a flowchart illustrating operation of the content modifying device;

FIG. 16 is a diagram illustrating a content updating method using a content supply device and a content collecting device;

FIG. 17 is a diagram illustrating a content retransmission method using the content supply device and the content collecting device;

FIG. 18 is a flowchart illustrating the content updating method using the content supply device and the content collecting device;

FIG. 19 is a flowchart illustrating the content retransmission method using the content supply device and the content collecting device; and

FIG. 20 is a diagram illustrating a conventional information provision service using a WWW server.

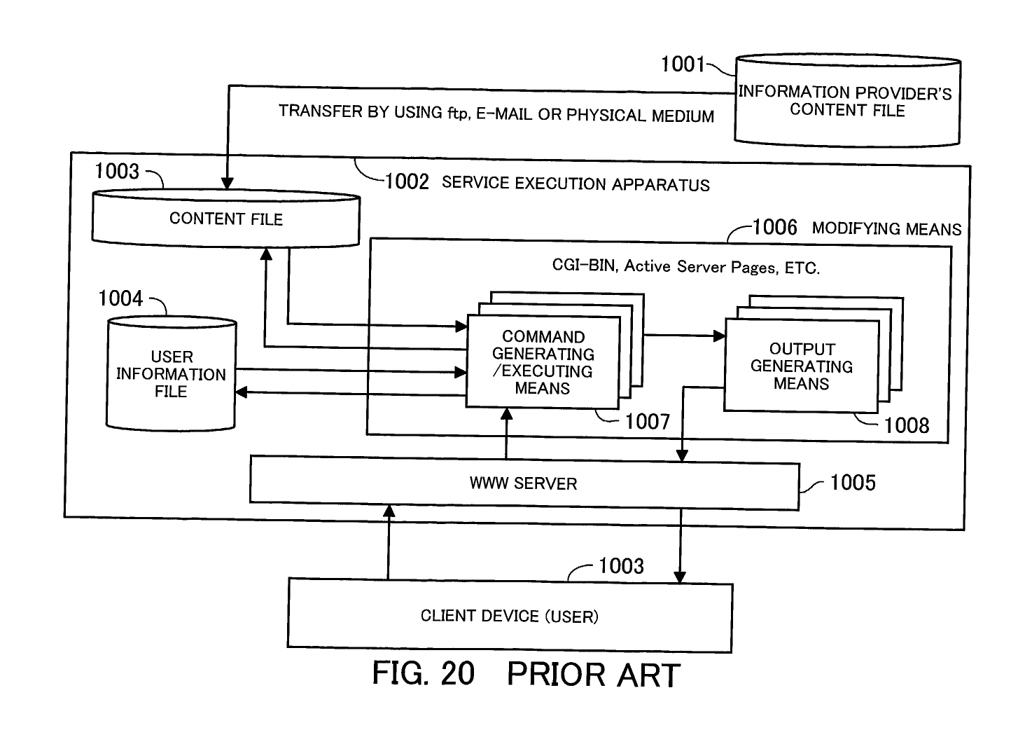

### DESCRIPTION OF THE PREFERRED EMBODIMENTS

Embodiments of the present invention will be hereinafter described with reference to the drawings. In the drawings illustrating the embodiments, reference numerals and signs are used consistently to denote identical elements.

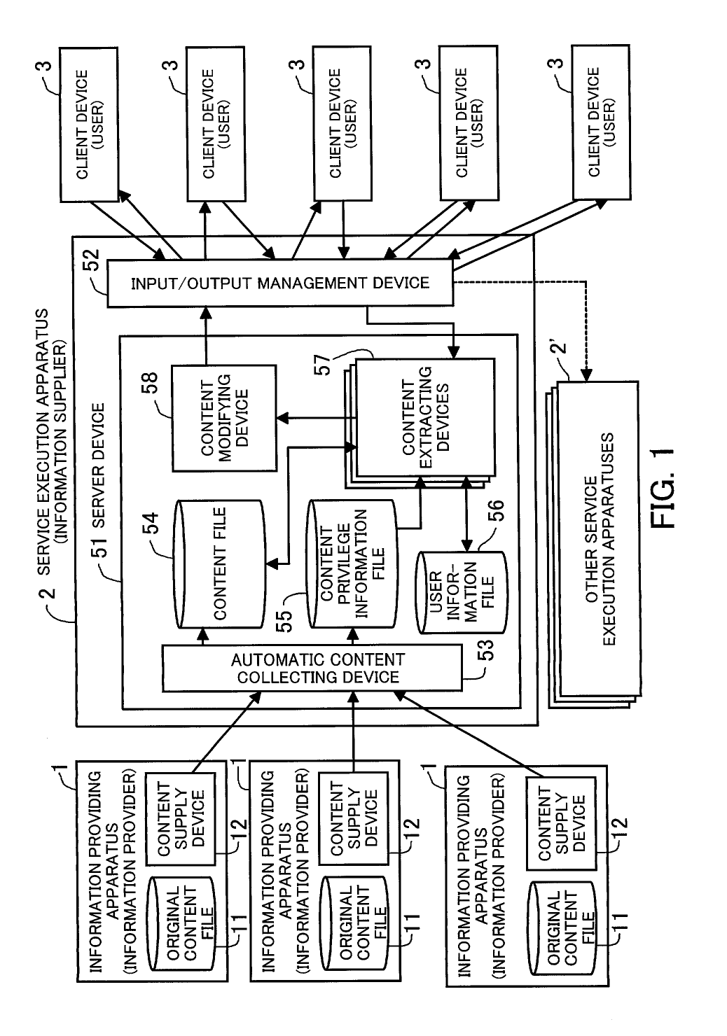

FIG. 1 schematically illustrates an exemplary configuration of a system used in the present invention.

Information providers, who have contracted with an information supplier for the provision of information, supply content from their own information providing apparatuses 1 to the information supplier's service execution apparatus 2. The service execution apparatus 2 provides services in compliance with requests from users' client devices 3. These apparatuses and terminals are interconnected by a network such as the Internet.

In the system used in this embodiment, the service execution apparatus 2 also includes a plurality of apparatuses, like the information providing apparatuses 1 and the client devices 3.

Each information providing apparatus 1 has an original content file 11 storing original content of information to be provided, and a content supply device 12 for supplying the content to the service execution apparatus 2.

The service execution apparatus 2 includes a server device 51 and an input/output management device 52. The other service execution apparatuses than the apparatus 2 are indicated at a different reference numeral “2′” for simplicity of explanation.

The server device 51 includes an automatic content collecting device 53 for collecting content supplied from the information providing apparatuses 1, a content file 54 for storing the collected content, a content privilege information file 55 storing privilege information about the content, a user information file 56 storing user information, a content extracting device 57 for extracting content in forms matching users' requests based on the content privilege information and the user information, and a content modifying device 58 for modifying the content information so as to match the users' client devices 3.

Users send a service request to the server device 2 through their respective client devices 3.

Each service request thus sent to the service execution apparatus 2 is supplied to the server device 51 through the input/output management device 52. The input/output management device 52 checks the loaded state of the server device 51. If it is judged that the load on the server device is high, the device 52 selects one of the other service execution apparatuses 2′ having an identical function and requests the same to execute the service.

In case the other service execution apparatuses 2′are found to be unable to perform the process, the input/output management device 52 lists the request in a queue and notifies the corresponding client device 3 that the request is waiting to be processed. When the load on the server device 51 has become low, the necessary process is executed and the result is returned to the client device.

In cases where it is judged that the service can be executed by the server device 51, the service request is sent to the content extracting device 57 in the server device 51.

The content extracting device 57 is made up of a plurality of devices so as to deal with a plurality of service requests. These devices serve to fetch information in such forms as to match users' requests from among groups of service content to be provided, for example, groups of article data including Japan's domestic hot news (e.g., on extraordinary Diet session), domestic hot financial news (e.g., announcement of estimated GDP for this fiscal year), overseas hot news, overseas hot financial news, sports news flashes, weather forecast, current stock prices, etc. Statistical data such as search count and time is also fetched as service for users.

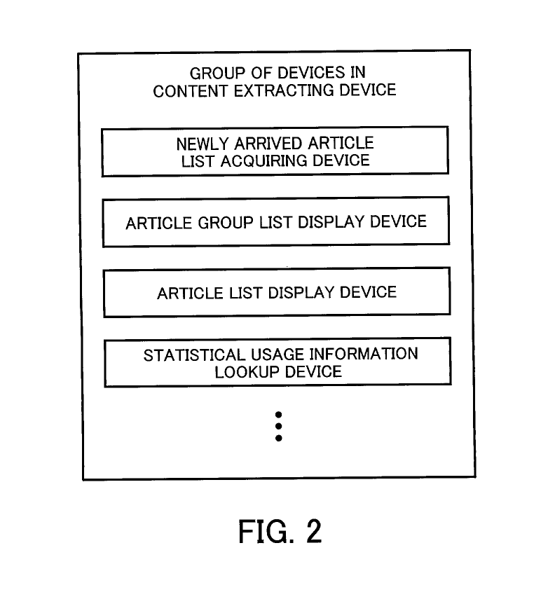

FIG. 2 exemplifies a group of devices included in the content extracting device 57. The devices include, for example, a device for acquiring a list of newly arrived articles, an article group list display device, an article list display device, a statistical usage information lookup device, etc.

The newly arrived article list acquiring device selects, from among the article data, only those latest articles which are registered after the user's last access time or a preset time.

The article group list display device extracts a list of article groups (items of articles) included in the article data.

The article list display device extracts a list of articles registered in article groups selected by the user, in the form of, for example, a tree structure.

The statistical usage information lookup device acquires information, such as a total number of times the user has used the service from the start of subscription, change of use counts in terms of fixed period (e.g., one week, one month), numbers of times the user has referred to specific article groups, etc., from a database storing such user information.

Referring again to FIG. 1, the content extracting device 57 extracts content of the requested service in such a form as to comply with the user's request, by making reference to the content file 54, the content privilege information file 55 and the user information file 56, and supplies the extracted content to the content modifying device 58.

The content modifying device 58 modifies the content into a form suited to the client device 3, and transmits the thus-modified content of the requested service to the client device 3 (user) through the input/output management device 52.

The automatic content collecting device 53 automatically collects content in the information providing apparatuses 1 in cooperation with their content supply devices 12, and creates and updates the contents of the content file 54 and content privilege information file 55.

Although not illustrated in the figure, also when the service execution apparatus 2 is requested from another service execution apparatus 2′ to process a service, it performs a similar process and supplies the content obtained to the service execution apparatus 2′. In the event that the load on the service execution apparatus 2 is high, the apparatus requests yet another apparatus to process the service.

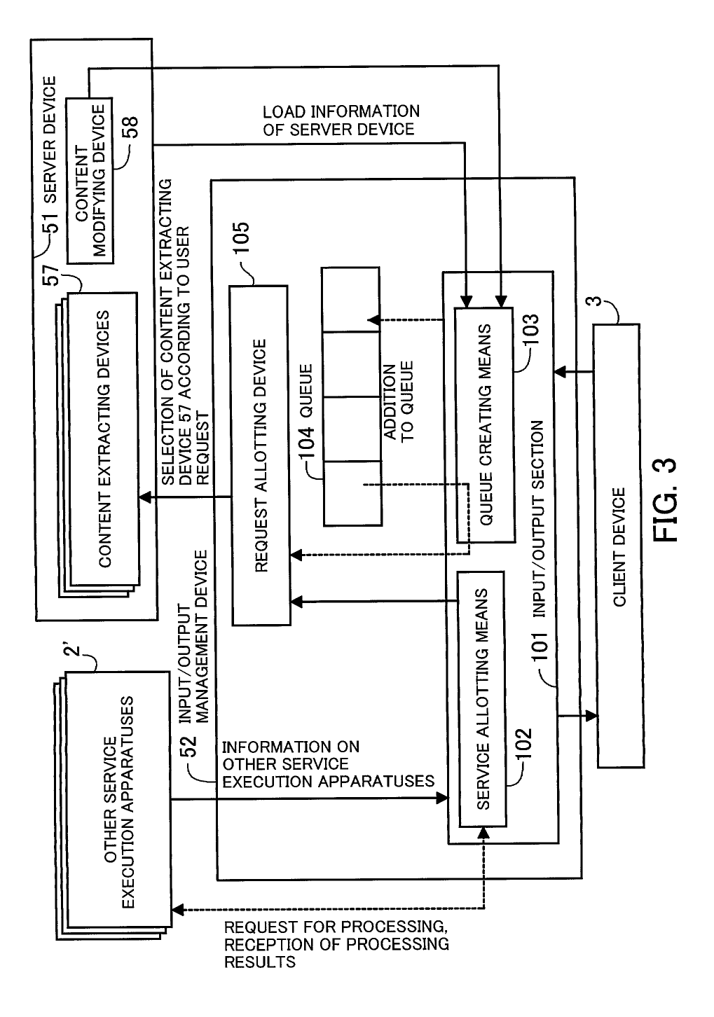

The input/output management device 52 will be now described with reference to FIG. 3 illustrating the configuration thereof.

The input/output management device 52 has an input/output section 101, through which a service request and content are respectively received from and delivered to the client device 3.

The input/output section 101 is supplied with load information from the server device 51, and when a load indicated by the information is higher than a predetermined value, the service request is dealt with by means of service allotting means 102 or queue creating means 103 in the input/output section 101.

The loaded state may be determined by methods described below.

A first method is to use an index which the OS of the server has as an index indicative of the weight of load. For example, if the OS is UNIX-based, “load average” may be used for the purpose, and if the OS is Windows NT, the CPU occupation rate or the amount of memory used may be used. If such an index exceeds a preset value, it is judged that the load is high.

The value to be set depends on the server device or the OS and cannot be unconditionally determined; it may be set to a value at or above which 100% will be exceeded if a new process is performed or may be empirically set to a value at or above which the operation of the server device will become unstable if a new process is performed.

A second method is to use an average value of response times. In this case, an average value of time periods from the reception of user request to the return of response is obtained, and if the average value exceeds a predetermined value, it is judged that the load is high.

Also in this case, the predetermined value may be empirically set to, for example, 20% or 50%.

The service allotting means 102 is supplied with load information of the other server devices from the other service execution apparatuses 2′. When it is judged that service can be processed by some other service execution apparatus 2′, the service allotting means requests the apparatus 2′ to process the service and receives the results of processing.

When it is judged by the input/output section 101 that the other service execution apparatuses 2′ also are highly loaded and unable to process the service, the queue creating means 103 adds the service request to a queue 104. At this time, the input/output section 101 notifies the client device 3 (user) that the response will be delayed.

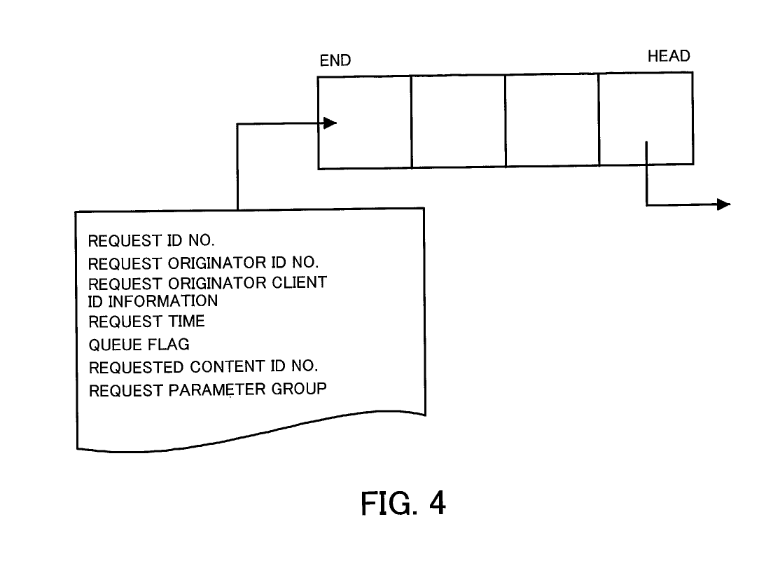

FIG. 4 shows an example of the queue 104, which is of a first-in, first-out type. In the queue, request identification number, request originator identification number, request originator client identification information, request time, queue flag, requested content identification number and request parameter group are stored in a manner associated with one another.

Referring again to FIG. 3, when the server device 51 can perform process, a user's service request accepted by the input/output section 101 is sent to a request allotting device 105, or a service request at the head of the queue 104 is sent to the request allotting device 105 by the queue creating means 103.

Based on information identifying a service and description of service execution conditions included in the user request, the request allotting device 105 selects a content extracting device 57 matching the request and requests the same to perform the process. At this time, if the corresponding content extracting device 57 is not in operation, it is started.

The content extracting device 57 extracts content related to the requested service and sends the content to the content modifying device 58, which then modifies the content into a form suited to the client device 3 and sends the modified content to the input/output section 101.

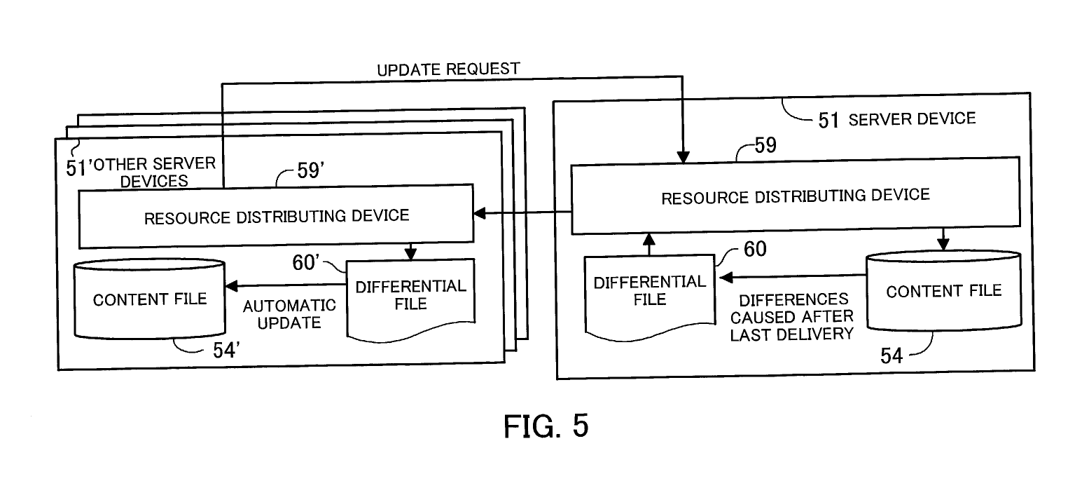

FIG. 5 illustrates a scheme for synchronization of content between the server device 51 of the service execution apparatus 2 and the server devices 51′ of the other service execution apparatuses 2′.

The server device 51 has the content file 54, a resource distributing device 59 and a differential file 60. Similarly, the server devices 51′ of the other service execution apparatuses 2′ each have a content file 54′, a resource distributing device 59∝ and a differential file 60′.

The resource distributing devices 59′ of the server devices 51′ send a content update request to the resource distributing device 59 of the server device 51 according to preset schedule.

On receiving the update request, the resource distributing device 59 looks up the content file 54 to extract differences of the content that have been caused after the preceding delivery time, and stores the differences in the differential file 60 to update the same. The contents of the differential file 60 are then sent to the resource distributing devices 59′ of the other server devices 51′.

Each resource distributing device 59′ stores the received contents in the differential file 60′ and updates the content file 54′ by using the differences.

The above update operation is automatically performed at regular intervals according to the preset schedule, whereby the contents of the content file 54 provided in the server device 51 of the service execution apparatus 2 and the contents of the content files 54′ in the server devices 51′ of the other service execution apparatuses 2′ can be automatically made to coincide with one another.

The content file 54 and the content files 54′ may not necessarily be perfectly identical in content. Only a specified content group may be made identical, or the content files 54 and 54′ may be divided into specified content groups and the groups may individually be made to be perfectly identical in content.

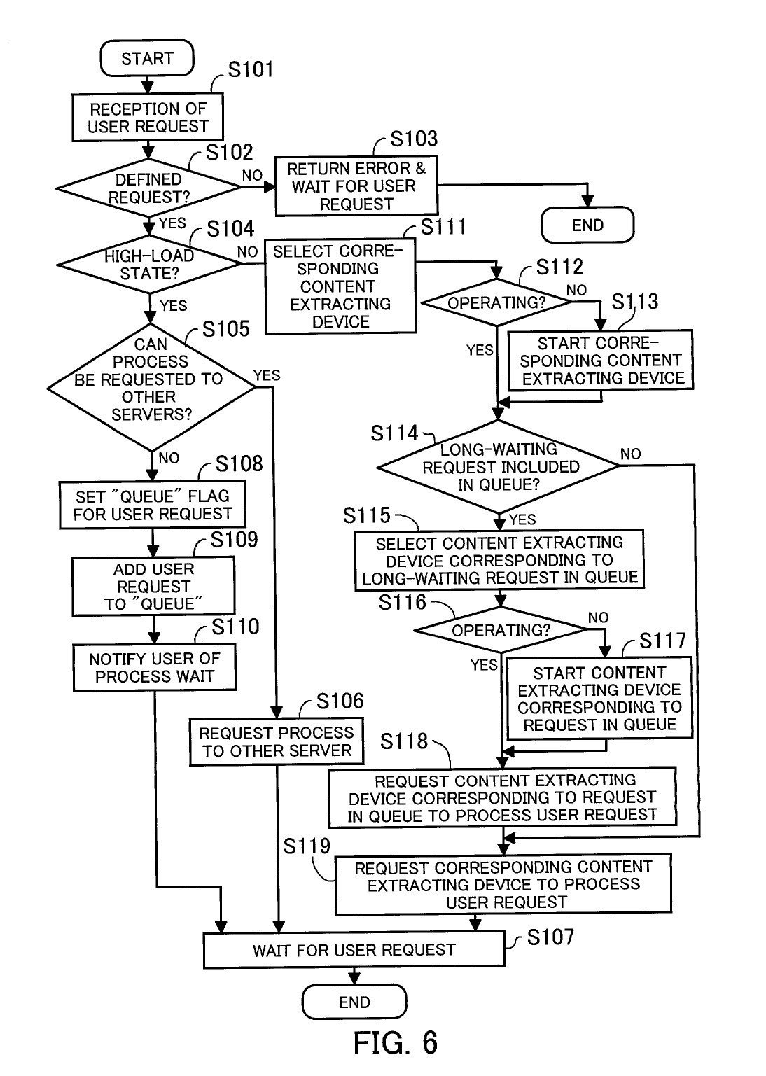

The flow of operation of the input/output management device 52 will be now described with reference to the flowchart of FIG. 6.

First, in Step S101, a user's service request is received from the client device 3.

Then, in Step S102, information identifying the service requested by the user is looked up to determine whether or not the user's request is a defined request. If the user request is not a service request that can be processed by the content extracting device or modifying device of the service execution apparatus (including the other service execution apparatuses) and it is judged that the request is not a defined request, the flow proceeds to Step S103, in which error notification is sent to the corresponding user's client device 3 and the process is suspended to wait for a next request.

If it is judged in Step S102 that the user request is a defined request, the flow proceeds to Step S104 to check the loaded state of the server device 51 of the service execution apparatus 2. If the load on the server is high, the flow proceeds to Step S105, in which a determination is made based on the operating states of the server devices 51′ (other servers) of the other service execution apparatuses 2′, the network connection conditions, etc. as to whether or not it is possible to request the other server devices 51′ to process the request.

If it is judged that the other server devices 51′can be used, the flow proceeds to Step S106, wherein one of the available server devices is selected and the user request is sent to the selected server device. The flow then proceeds to Step S107 to wait for a request.

If it is judged in Step S105 that the other server devices 51′ also cannot be used, the flow proceeds to Step S108, in which a queue flag is set for the user request, and then to Step S109, in which the user request is added to the queue.

Subsequently, in Step S110, a message to the effect that “the service execution results will be notified at a later time” is sent to the user (client device 3), whereupon the flow proceeds to Step S107 and waits for a request.

If it is judged in Step S104 that the server device 51 is not highly loaded and can process the request, the flow proceeds to Step S111, in which a content extracting device 57 for executing the service request is selected in accordance with the information identifying the service indicated by the user service request, the service execution conditions, etc.

Then, in Step S112, it is determined whether or not the content extracting device 57 selected to perform the request is in operation. If the device is in operation, the flow proceeds directly to Step S114; if not, the flow proceeds to Step S113 to start the corresponding content extracting device 57, and then to Step S114.

In Step S114, it is determined whether or not the queue includes a request which has been waiting for a long time to be processed. If such a request exists, the flow proceeds to Step S115 to select a content extracting device 57 corresponding to the request.

Subsequently, in Step S116, it is determined whether or not the content extracting device 57 corresponding to the service request in the queue is in operation. If the device is in operation, the flow proceeds directly to Step S118; if not, the flow proceeds to Step S117 to start the corresponding content extracting device 57, and then to Step S118.

In Step S118, the content extracting device 57 corresponding to the request in the queue is requested to process the user request.

Then, in Step S119, the content extracting device 57 corresponding to the request is requested to process the user request.

Subsequently, the flow proceeds to Step S107 and waits for a user request.

If it is judged in Step S114 that the queue does not include a request which has been waiting for a long time to be processed, the flow proceeds directly to Step S119 to request the corresponding content extracting device 57 to process the user request, and then to Step S107 to wait for a user request.

In the process described above, a long-waiting service request in the queue is processed preferentially over the service request newly received from a user. However, the manner of processing requests is not limited to this alone, and priority values may be assigned to individual requests including those accumulated in the queue so that the requests may be processed in order of priority by the content extracting devices.

Also, in the above process, in cases where the other service execution apparatuses 2′ are unable to process a user request, the request is added to the queue. Instead of using the queue, a message may simply be sent to the user to inform him/her that the request cannot be processed and request him/her to send the request again later.

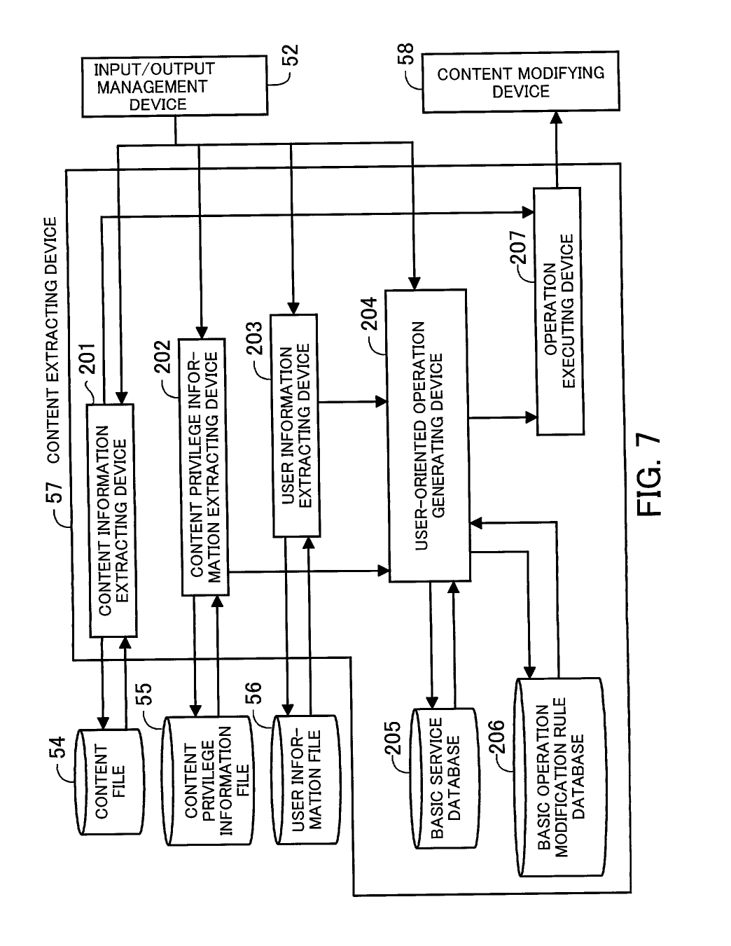

The configuration of the content extracting device 57 will be now described with reference to FIG. 7.

The content extracting device 57 includes a content information extracting device 201, a user information extracting device 202, a content privilege information extracting device 203, a user-oriented operation generating device 204, a basic service database 205, a basic operation modification rule database 206, and a operation executing device 207.

A user request sent from the input/output management device 52 is supplied to the content information extracting device 201, the user information extracting device 202, the content privilege information extracting device 203, and the user-oriented operation generating device 204.

In accordance with the execution conditions for the service requested from the user, the content information extracting device 201 identifies content to be used in the service, extracts the corresponding content information from the content file 54, and supplies the results to the operation executing device 207.

Based on the user request, the user information extracting device 202 extracts information identifying the user, extracts corresponding user attributes from the user information file 56, and supplies the results to the user-oriented operation generating device 204.

The content privilege information extracting device 203 extracts privilege information of the content requested by the user from the content privilege information file 55, and supplies the results to the user-oriented operation generating device 204.

The basic service database 205 stores information about basic service operation sequences, and the basic operation modification rule database 206 stores rules for modifying the basic service by using the user attributes and the content privilege information.

Specifically, the operation sequence signifies a program for searching or updating the database, and an example is a program described using SQL statements or by JAVA.

The user-oriented operation generating device 204 extracts information about a procedure for executing the basic service, from the basic service database 205. Also, based on the user information and the content privilege information supplied respectively from the user information extracting device 202 and the content privilege information extracting device 203, the user-oriented operation generating device modifies the information on the service execution procedure according to a modification rule extracted from the basic operation modification rule database 206, to generate a operation sequence (execution procedure) suited to each user.

In accordance with the operation sequence generated for each user, the operation executing device 207 operates the content information supplied from the content information extracting device 201, and supplies the results to the content modifying device 58. If the content modifying device 58 is not in operation, it is started. The operation executing device 207 may not necessarily be included in the content extracting device 57 and may be provided as a separate device.

In the user information stored in the user information file 56, user attributes are held as a collection of attribute name-attribute value pairs.

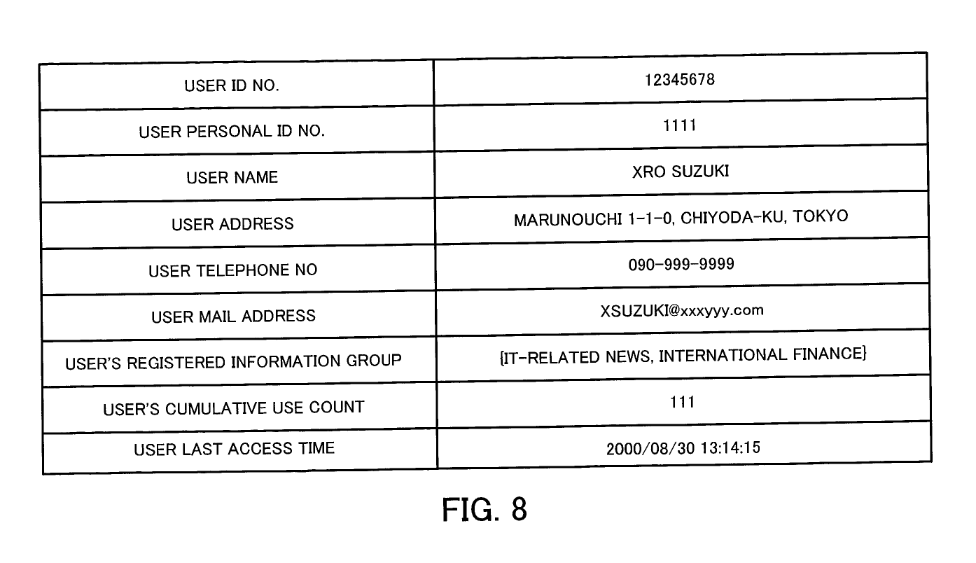

FIG. 8 shows an example of the user information stored in the user information file 56.

In this example, user's identification number, personal identification number, name, address, telephone number, electronic mail address, user's registered article group, access count during the period from the registration up to the present, and last access time are stored as the user information in a manner associated with one another. The information is registered in the form of a hash table, for example.

In FIG. 8, the user identification number is “1234567”, the personal identification number is “1111”, the name is “Xro Suzuki”, the address is “Marunouchi 1-1-0, Chiyoda-ku, Tokyo”, the telephone number is “090-999-9999”, the electronic mail address is “xsuzuki@xxxyyy.com”, the registered article genre is “IT-related News, International Finance”, the access count is “111”, and the last access time is “2000/08/30 13:14:15” (13:14:15, Aug. 30, 2000).

The user attributes stored as the user information are used for the basic service modification (including a determination as to whether the modification is needed or not) by the user-oriented operation generating device 204.

The attribute names of the user attributes may be fixed or may be added or deleted as needed by the service execution apparatus 2 (information supplier).

The attribute values can be changed not only by the service execution apparatus 2 but by the information providing apparatus 1 (information provider).

The content privilege information stored in the content privilege information file 55 is held as a collection of attribute name-attribute value pairs. Addition/deletion of attributes to/from the content privilege information and the attribute value settings can be performed as needed by the information provider, and such modified information can be automatically reflected in the information providing apparatus 1 (information provider) through the automatic content collecting device 53.

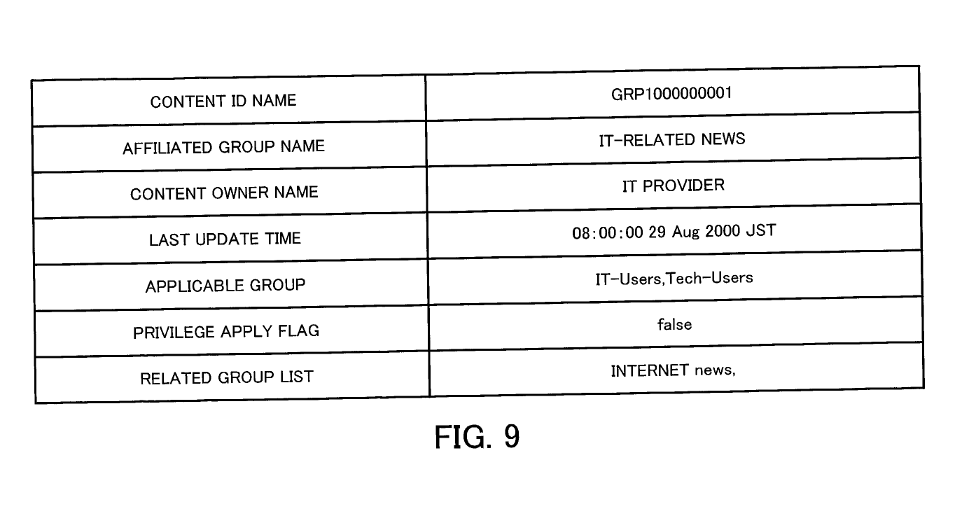

FIG. 9 shows an example of the content privilege information stored in the content privilege information file 57.

In this example, content identification name, affiliated group name, content owner name, last update time, applicable user group, privilege apply flag and related group list are stored as attribute information in a manner associated with one another. The individual attributes and attribute values can be set or changed as needed by the information provider.

In FIG. 9, the content identification name is “GRP1000000001”, the affiliated group name is “IT-related News”, the content owner name is “IT Provider”, the last update time is “08:00:00 05 Sep 2000 JST” (8:00:00, Sep. 5, 2000, Japan Standard Time), the applicable user group is “IT-Users, Tech-Users”, the privilege apply flag is “false”, and the related group list is “Internet news, . . . .”

The attributes stored as the content privilege information are also used for the basic service modification (including a determination as to whether the modification is needed or not) by the user-oriented operation generating device 204. The content privilege information is set for each content group (e.g., directory).

The rule for modifying the basic service by using the user attributes and the content privilege information comprises a condition section and a operation section. The condition section is constituted by a collection of conditional clauses indicating the relationships of the user attributes and the attribute names and values of the content privilege information, and an identification name for the operation of the basic service. The operation section is constituted by operation units, such as addition of operation to the basic service operation, and addition or change of parameters with respect to the basic service operation.

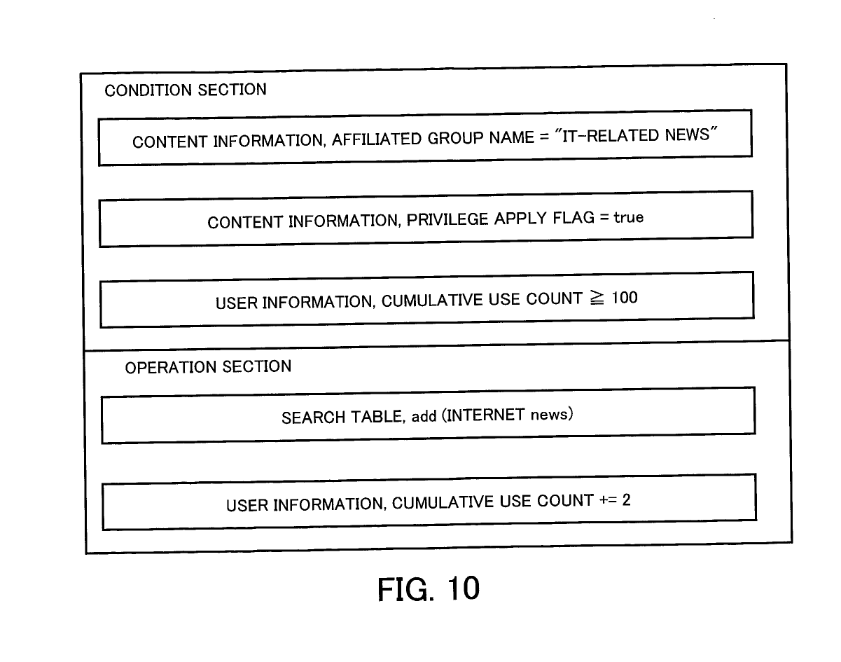

FIG. 10 shows a specific example of the modification rule used in the present invention to modify the basic service operation. The modification rule is divided into the condition section and the operation section, as stated above.

The condition section comprises sets of dyadic relationships between attribute names (relationship of equivalence, non-equivalence, relative magnitude or inclusion) combined by AND or OR, and the identification name for the operation.

The operation section enumerates additions of operations to the basic service and additions or changes of operation parameters for respective operations.

In the example of FIG. 10, on condition that the affiliated content group is “IT-related News”, that the privilege apply flag is “true” (i.e., privilege is applicable) and also that the cumulative number of times the user has used the service is “100” or more, “Internet news” is added to the scope of search and the cumulative use count is incremented by “2”, instead of “1”, as privileges.

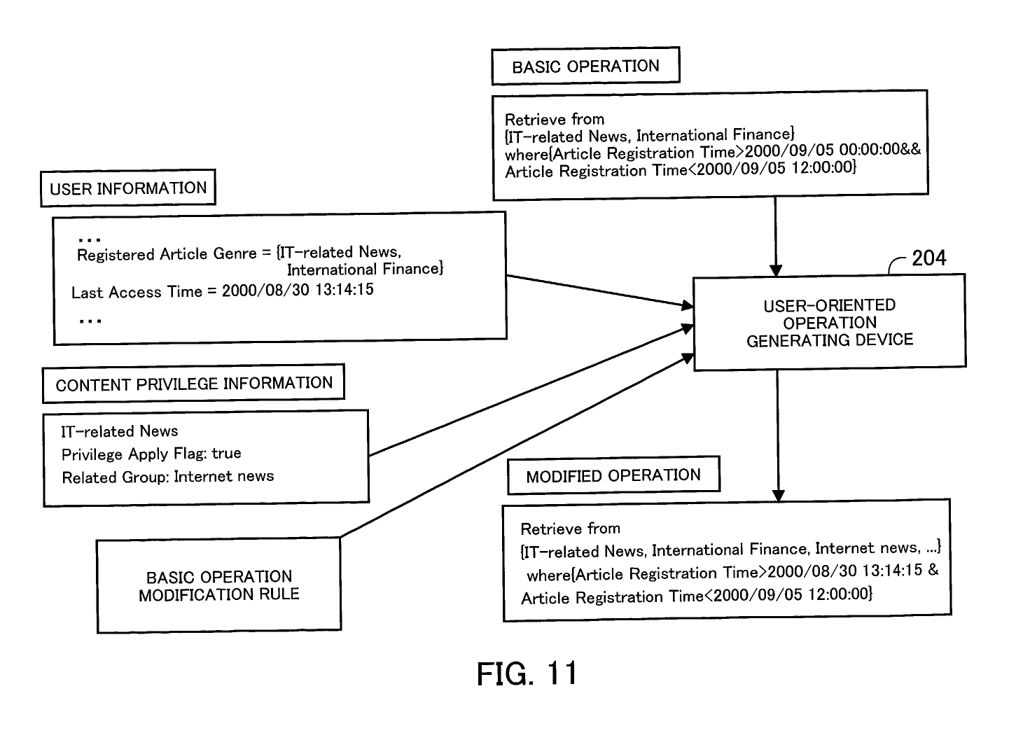

FIG. 11 shows an example of service execution (generation of user-oriented operation) by the user-oriented operation generating device 204.

In FIG. 11, the basic operation denotes a operation sequence for executing a basic service stored in the basic service database 205, and the modified operation denotes a operation sequence modified by the user-oriented operation generating device 204. The user information, the content privilege information and the basic operation modification rule respectively correspond to those explained with reference to FIGS. 8, 9 and 10.

In the operation sequence for the basic service is prescribed that the IT-related news and international financial news registered during the period from 0:00 a.m. to noon of Sep. 5, 2000 should be returned.

In the user information, “IT-related News” and “International Finance” are registered as the article genre, and “13:14:15, Aug. 30, 2000” is registered as the last access time.

In the content privilege information is prescribed that if the privilege apply flag of a user who has registered “IT-related News” is “true”, information about the related group “Internet news” can also be obtained.

Looking up these items of information, the user-oriented operation generating device 204 applies the basic operation modification rule (cf. FIG. 10) to the basic operation sequence and obtains, as a modified operation sequence, the operation sequence prescribing that the articles of IT-related news, international financial news and Internet news registered during the period from the last access time, that is, 13:14:15, Aug. 30, 2000, to noon of Sep. 5, 2000 should be returned.

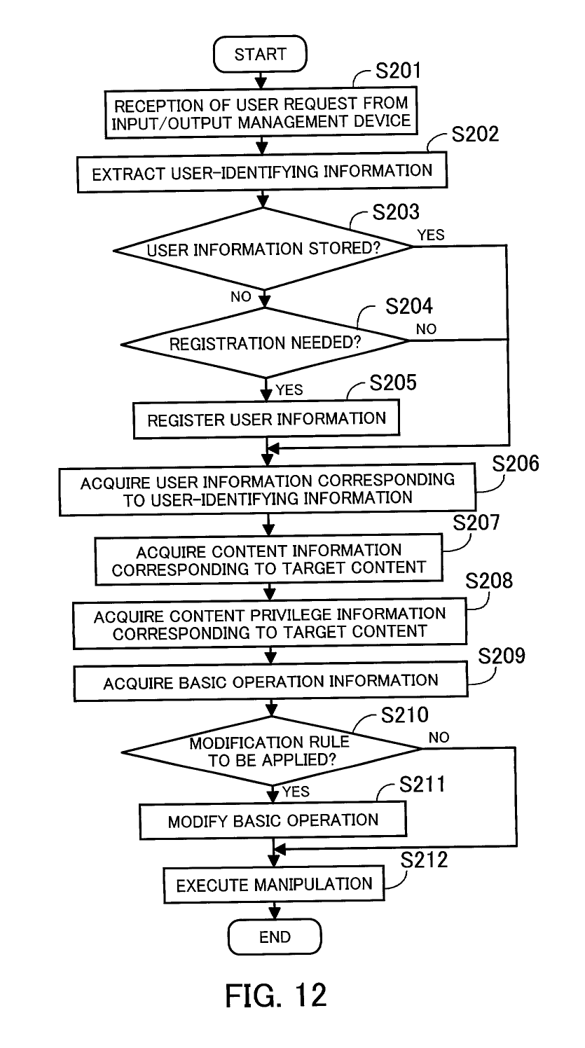

The flow of operation of the content extracting device 57 will be now described with reference to the flowchart of FIG. 12.

First, in Step S201, a user request is received from the input/output management device 52.

Then, in Step S202, information identifying the user is extracted from the user request.

Subsequently, it is determined in Step S203 whether or not user information corresponding to the user-identifying information has been stored in the user information file 56.

If the user information file 56 does not include user information corresponding to the received information identifying the user, the flow proceeds to Step S204; if such user information is included, the flow proceeds to Step S206.

The request information from the user is looked up in Step S204 to determine whether or not user information needs to be registered. If user information needs to be registered, the flow proceeds to Step S205; if not, the flow proceeds to Step S206.

In Step S205, a process for registering the user in the user information file 56 is executed.

Then, in Step S206, the user information is acquired from the user information file 56. In the case where there is no corresponding user information and at the same time it is judged that the registration of user information is unnecessary, virtual user information set in advance is used.

Subsequently, based on the user request, information identifying a service and the description of service execution conditions are analyzed, in Step S207, to identify the content to be used in executing the service, whereupon the content file 54 is looked up to acquire the corresponding content information.

Then, the content privilege information file 55 is looked up, in Step S208, to acquire content privilege information corresponding to the content.

In Step S209, in accordance with the service-identifying information and the description of the service execution conditions in the user request, an applicable basic service is extracted from the basic service database 205.

Then, looking up the user information and the content privilege information, it is determined in Step S210 whether or not a basic service modification rule acquired from the basic operation modification rule database 206 should be applied. If the rule is to be applied, the flow proceeds to Step S211, in which operation is added to the operation sequence for the basic service or the operation execution conditions are changed, and then to Step S212; if the rule is not applied, the flow proceeds directly to Step S212.

In Step S212, the operation sequence, which has been modified or is the basic operation itself, is executed and the results of execution are transferred to the content modifying device 58 together with the user request.

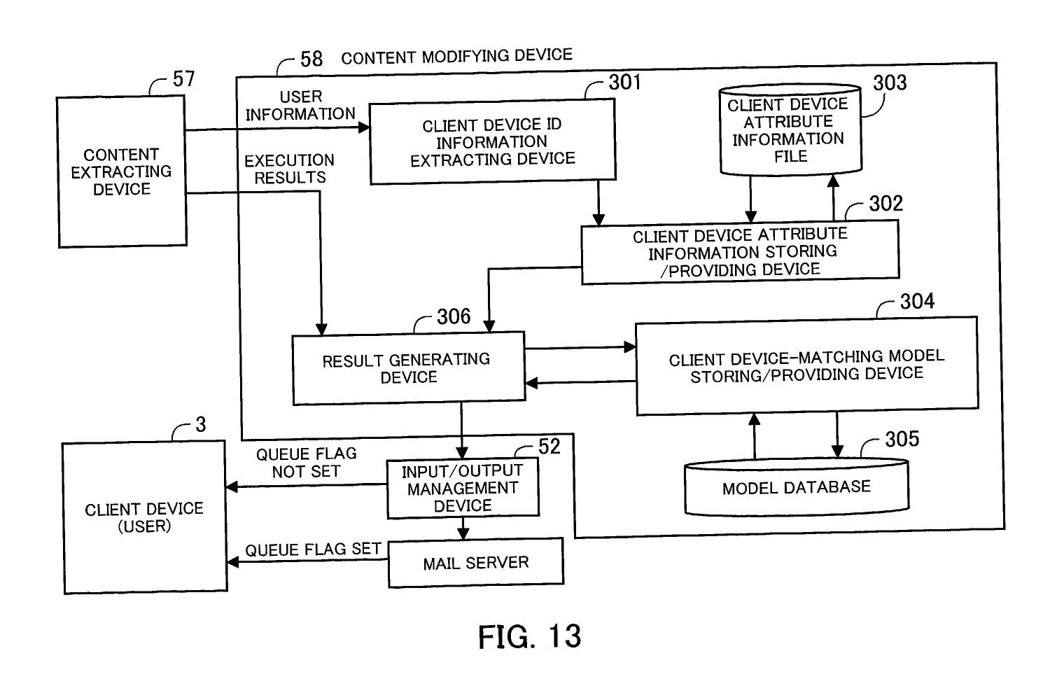

The configuration of the content modifying device 58 will be now described with reference to FIG. 13.

The content modifying device 58 includes a client device identification information extracting device 301, a client device attribute information storing/providing device 302, a client device attribute information file 303, a client device-matching model storing/providing device 304, a model database 305, and a result generating device 306.

The client device identification information extracting device 301, which is a device for extracting information identifying a client device used by a user, identifies a client device used by the user, based on the user information supplied from the content extracting device 57, and sends the information obtained to the client device attribute information storing/providing device 302.

The client device attribute information storing/providing device 302 looks up the client device attribute information file 303, based on the received client device identification information, to obtain attribute information corresponding to the client device used by the user, and supplies the obtained attribute information to the result generating device 306.

In the case of a new client device, the client device attribute information storing/providing device 302 stores the attribute information of the client device in the client device attribute information file 303.

The result generating device 306 supplies the received client device attribute information to the device 304 which stores/provides models matching client devices. The client device-matching model storing/providing device 304 looks up the model database 305 to acquire a model matching the client device 3, and supplies the model to the result generating device 306.

If the received client device attribute information is new one, the client device-matching model storing/providing device 304 stores a new model in the model database 305.

Based on the execution results supplied from the content extracting device 57 and the model supplied from the client device-matching model storing/providing device 304, the result generating device 306 creates content and supplies the same to the input/output management device 52.

In this case, the content modifying device 58 determines whether or not a queue flag has been set for the user request, and if a queue flag has been set, the service execution results are sent by electronic mail or a like means to the user's client device 3 through the input/output management device 52.

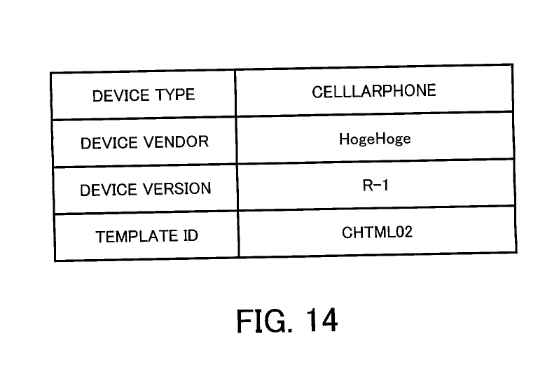

FIG. 14 shows an example of client device information used in the present invention.

In this example, type, vendor and version of client device and identification name of result template are stored as the client device information in a manner associated with one another. These data items constituting the client device information are also registered in the form of a hash table etc.

In FIG. 14, the type of the client device is “CELLLARPHONE”, the vendor of the client device is “HogeHoge”, the version of the client device is “R-1”, and the identification name of the result template is “CHTML02”.

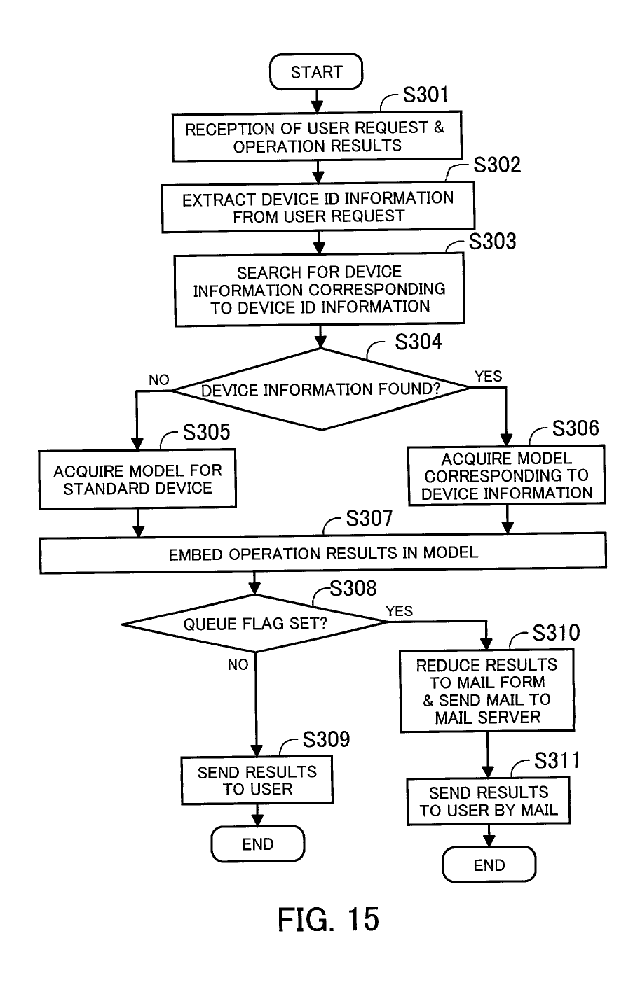

The flow of process of the content modifying device 58 will be now described with reference to the flowchart of FIG. 15.

First, in Step S301, the service execution results and the user request are received form the content extracting device 57.

Then, in Step S302, information identifying the client device 3 used by the user is extracted from the received user request.

Subsequently, in Step S303, based on the device identification information in the user request, the client device attribute information file is searched for attribute information corresponding to the client device 3.

It is then determined in Step S304 whether or not corresponding device information has been found. If there is no attribute information corresponding to the client device, the flow proceeds to Step S305, in which a model for a standard device is acquired, and then to Step S307.

The standard device may be previously specified by the content supplier or the content provider, or data about users' client devices may be acquired and the most frequently used device may be set as the standard device. Also, client devices may be grouped according to types, such as personal computer, PDA, portable telephone, etc., and one of the groups may be specified as the standard device as desired or in accordance with the frequency in use.

If it is judged in Step S304 that there is attribute information corresponding to the client device, the flow proceeds to Step S306, in which a model is acquired from the attribute information file corresponding to the client device, and then to Step S307.

In Step S307, the service execution results are embedded in the selected model. In this case, the received results may be used in original form.

Then, in Step S308, it is determined whether or not a queue flag has been set. If the flag has not been set, the flow proceeds to Step S309, wherein the results are sent to the user through the input/output management device 52.

If it is judged in Step S308 that the flag has been set, the flow proceeds to Step S310, wherein the results are reduced to electronic mail or like form and supplied to the mail server through the input/output management device 52.

Then, in Step S311, the results are sent to the user by mail.

Thus, according to the present invention, in cases where a user request cannot be immediately processed, not only the user is notified of the delay of processing but the user can be directly notified of the processing results per se by electronic mail etc. Consequently, the user need not again access the service execution apparatus and can quickly acquire desired content as soon as the server becomes able to process the request.

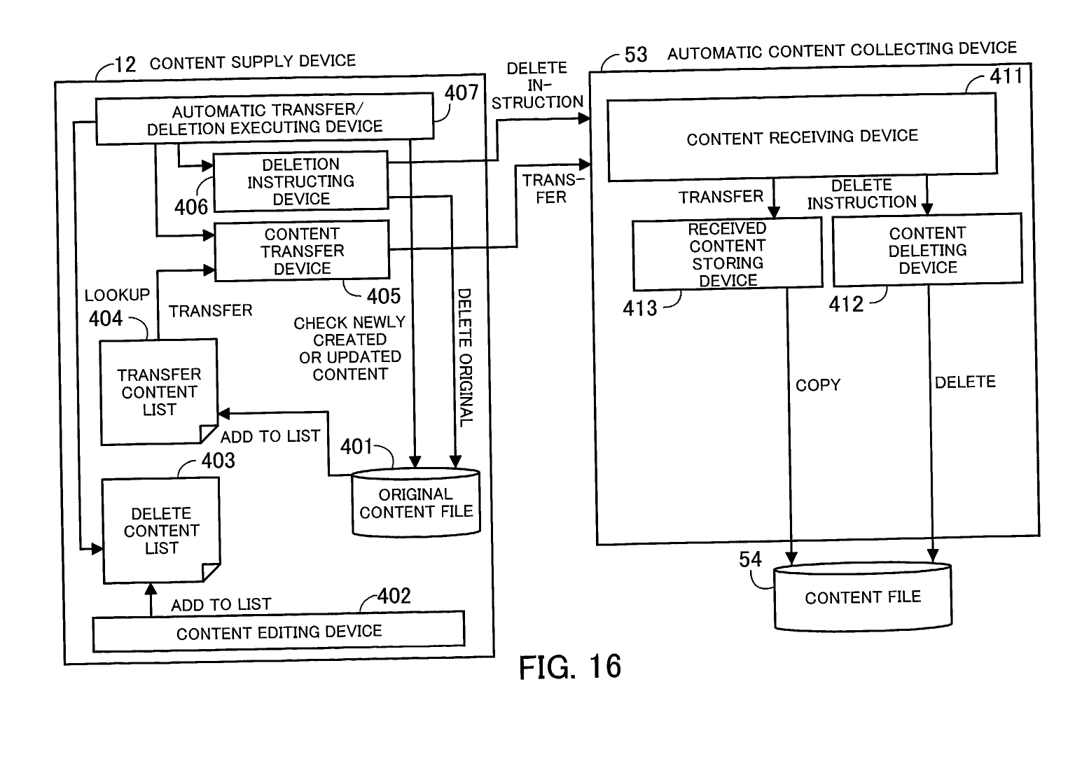

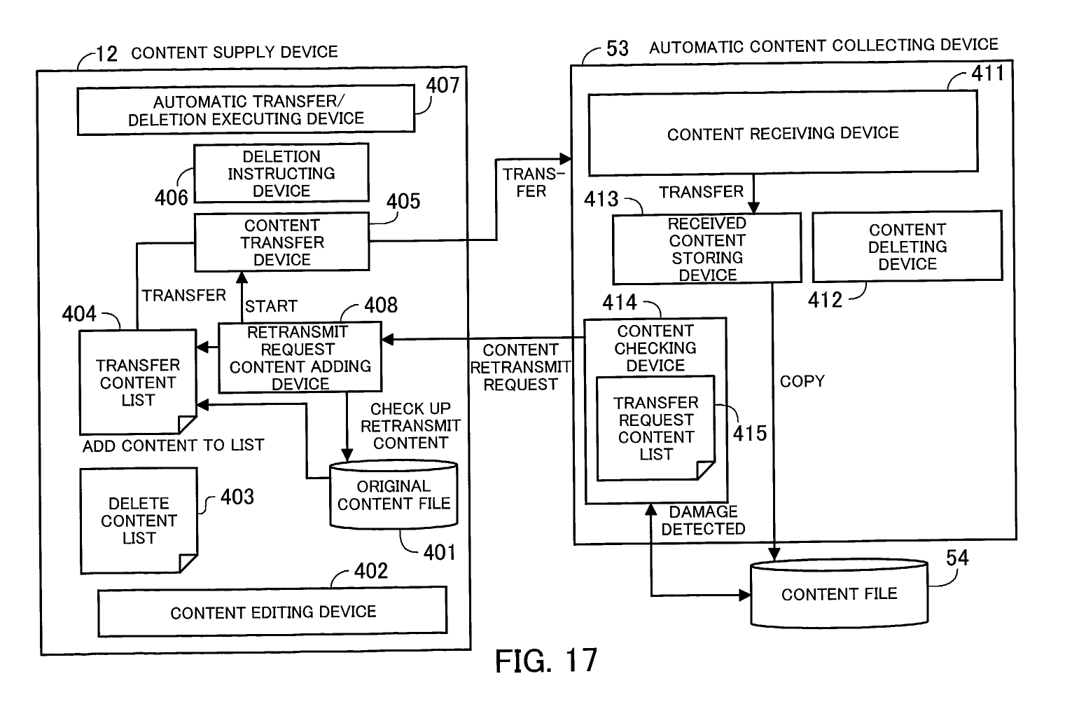

The configuration of an automatic content collection system using the content supply device 12 and the automatic content collecting device 53 will be now described with reference to FIGS. 16 and 17.

FIG. 16 illustrates a content updating method using the content supply device 12 and the content collecting device 53.

As shown in FIG. 16, the content supply device 12 of the information provider side includes an original content file 401, a content editing device 402, a delete content list 403, a transfer content list 404, a content transfer device 405, a deletion instructing device 406, and an automatic transfer/deletion executing device 407.

The automatic content collecting device 53 includes a content receiving device 411, a content deleting device 412, and a received content storing device 413.

Content created on the content provider side is stored in the original content file 401.

To delete content, the procedure described below is followed. The content provider adds content to be deleted to the delete content list 403 by operating the content editing device 402.

The automatic transfer/deletion executing device 407 looks up the delete content list 403 and, if the list includes content to be deleted, starts the deletion instructing device 406. The deletion instructing device 406 deletes the original in the original content file 401 and sends a delete instruction to the content receiving device 411 of the automatic content collecting device 53.

The automatic transfer/deletion executing device 407 automatically looks up the delete content list 403 at regular intervals of time.

In response to the received delete instruction, the content receiving device 411 supplies a delete instruction to the content deleting device 412, which then deletes corresponding content in the content file 54.

When content has been newly created or updated, the procedure described below is followed. The automatic content transfer/deletion executing device 407 looks up the original content file 401 to determine whether or not the file includes content that has been newly created or updated.

If there is content newly created or updated, such content is added to the transfer content list 404 and the content transfer device 405 is started.

The automatic transfer/deletion executing device 407 automatically looks up the original content file 401 at regular intervals of time. If the file has been updated since the preceding lookup time (transfer time), the device 407 adds corresponding content to the transfer content list 404.

The content transfer device 405 receives a list of transfer content from the transfer content list 404, and transfers the corresponding content to the content receiving device 411 of the automatic content collecting device 53.

The content receiving device 411 transfers the received content to the received content storing device 413, which then copies the content to the content file 54 to update the same.

Although not illustrated in the figure, the content receiving device 411 or the received content storing device 413 may be provided with a device for checking content, to determine at the time of reception of content whether or not the content has been transferred successfully. If the transfer of content ends in failure, a request may be sent to the content transfer device to again transfer the content.

In the above description, the deletion instructing device 406 and the content transfer device 405 are started by the automatic transfer/deletion executing device 407, but when these devices are already operating, they may simply be instructed to perform the necessary processes.

FIG. 17 illustrates retransmission of content.

There is a possibility that the content stored in the content file 54 is damaged or lost for some reason or other. In such cases, the contents of the content file 54 are automatically restored.

In the system shown in FIG. 17, the content supply device 12 is additionally provided with a retransmit request content adding device 408 while the automatic content collecting device 53 is additionally provided with a content checking device 414 and a transfer request content list 415, as compared with the system configuration shown in FIG. 16.

The content checking device 415 periodically checks the contents of the content file 54 to determine whether or not there is damaged or lost content. If damage to or loss of content is detected, the device 415 adds the name (identifier) of the content to the transfer request content list 415, and sends the list to the retransmit request content adding device 408 to request the same to retransmit the content.

The retransmit request content adding device 408 looks up the original content file 401, adds content with the name described in the transfer request content list 415 to the transfer content list 404, and starts the content transfer device 405.

The content transfer device 405 receives a list of transfer content from the transfer content list 404, and transfers the content to the content receiving device 411 of the automatic content collecting device 53.

The content receiving device 411 transfers the received content to the received content storing device 413, which then copies the content to the content file 54 to update the same.

In case the transfer of the content ends in failure, such failure may be detected by the content checking device 414 and a retransmit request may be again sent to the retransmit request content adding device 408. Also, although not illustrated in the figure, the content receiving device 411 or the received content storing device may be provided with a device for checking content, to determine at the time of reception of content whether or not the content has been transferred successfully. If the transfer of content ends in failure, a request may be sent to the content transfer device to again transfer the content.

Further, in the above description, the content transfer device 405 is started by the retransmit request content adding device 408, but when this device is already operating, it may simply be instructed to perform the necessary process.

In the automatic content collection system explained above with reference to FIGS. 16 and 17, content itself is added to the transfer content list 407 or the delete content list 406. Alternatively, only the identification name of content may be put on the lists, as in the transfer request content list 415, and the transfer or deletion may be performed by identifying the content by the identification name.

Also, a device for storing a backup of the content transferred from the content provider may be provided, and a backup of the content file 54 may be made at regular intervals. In the event that content is damaged, the backup may be used to restore the content, instead of sending a retransmit request to the content supply device.

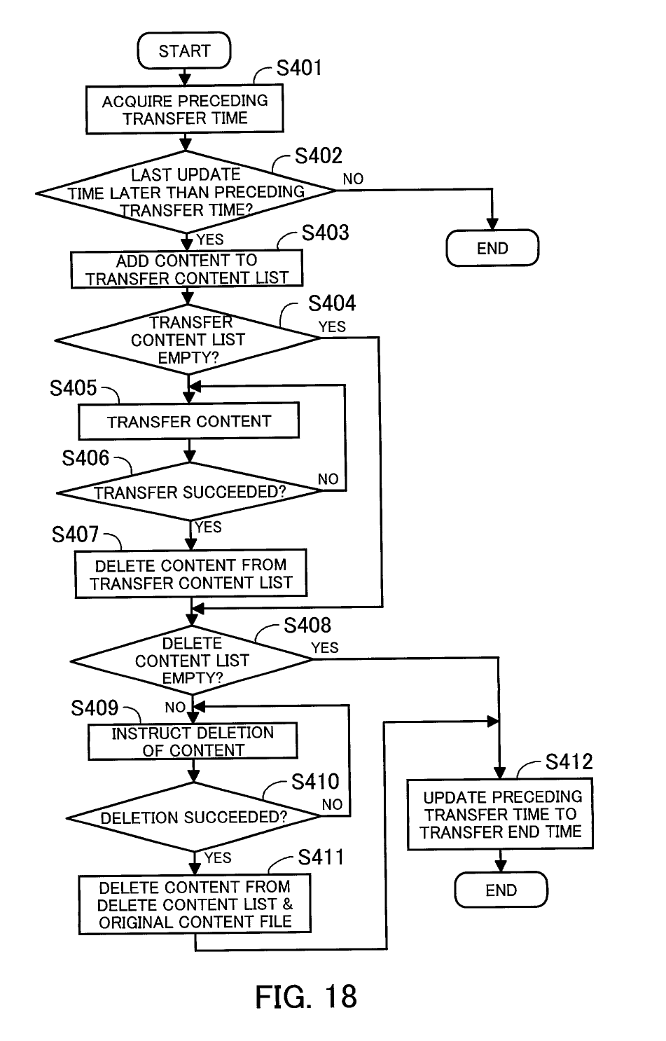

The flow of process for updating content by the automatic transfer/deletion executing device 407 will be now described with reference to the flowchart of FIG. 18.

First, in Step S401, the automatic transfer/deletion executing device 407 acquires the time at which content was transferred last time to the automatic content collecting device 53.

Then, in Step S402, the last update time of each content stored in the original content file 401 is checked, and content of which the last update time is later than the preceding transfer time is added to the transfer content list 404 (Step S403).

It is determined in Step S404 whether or not the transfer content list is empty. If the list is empty, the flow proceeds to Step S408; if not, the flow proceeds to Step S405.

In Step S405, each content in the transfer content list 404 is transferred by means of the content transfer device 405.

It is then determined in Step S406 whether or not the transfer was performed successfully. If the transfer met with success, the flow proceeds to Step S407, in which the corresponding content is deleted from the transfer content list 404; if the transfer failed, the flow returns to Step S405 and the content is again transferred.

Subsequently, in Step S408, it is determined whether or not the delete content list 406 is empty. If the delete content list is empty, the flow proceeds to Step S412; if not, the flow proceeds to Step S409.

In Step S409, the deletion instructing device 406 instructs the automatic content collecting device 53 to delete content corresponding to each content in the delete content list 403.

It is then determined in Step S410 whether or not the deletion was performed successfully. If the deletion failed, the flow returns to Step S409 to again instruct the deletion; if the deletion succeeded, the flow proceeds to Step S410, in which the corresponding content is deleted from both the delete content list 403 and the original content file 401.

Subsequently, in Step S412, the preceding transfer time is updated to a time at which this process was completed.

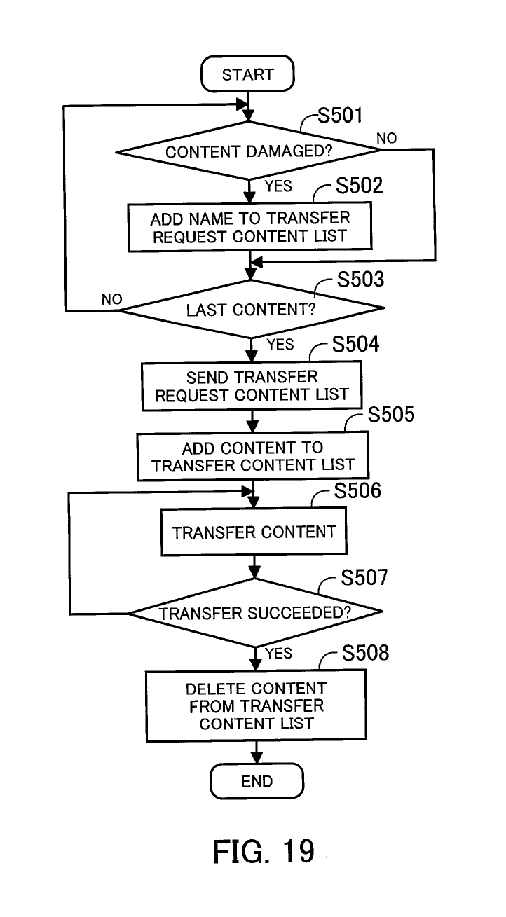

The flow of process for requesting retransmission by means of the content checking device 414 and the retransmit request content adding device 408 will be now described with reference to the flowchart of FIG. 19.

Content is stored in the content file 54 in a physically or logically separated manner according to information providers, and the transfer request content list 415 is created with respect to each information provider (the retransmit request content adding device 408 of each information provider).

First, in Step S501, the content checking device 414 looks up content in the content file 54 to determine whether it is damaged or not. If it is judged that the content is not damaged, the flow proceeds to Step S503. If the content is judged to be damaged, the flow proceeds to Step S502, in which the identification name of the content is added to the transfer request content list 415, and then to Step S503.

Then, in Step S503, it is determined whether or not up to the last content has been checked. If there still remains content that has not been checked, the flow returns to Step S501; if there is no such content remaining and it is judged that up to the last content has been checked, the flow proceeds to Step S504.

In Step S504, the content checking device 414 sends the contents of the transfer request content list 415 to the retransmit request content adding device 408 of the corresponding information provider.

Then, in Step S505, the retransmit request content adding device 408 starts the content transfer device 405; also, based on the contents of the transfer request content list 415 transmitted thereto, the device 408 looks up the original content file 401 and adds corresponding content to the transfer content list 404.

Subsequently, in Step S506, each content in the transfer content list 404 is transferred by the content transfer device 405.

It is then determined in Step S507 whether or not the transfer succeeded. If the transfer succeeded, the flow proceeds to Step S508, in which the corresponding content is deleted from the transfer content list 404; if the transfer failed, the flow returns to Step S506 and the content is again transferred.

According to the present invention, even while the service execution apparatus is busy, services can be provided to users without making them wait long.

Also, services can be provided to users while at the same time efficiently modifying the contents thereof in compliance with the users' wishes, privileges given to the users, and privileges of content used in executing the services.

Further, services can be provided to a wide variety of client devices by an identical mechanism, so that the mechanism for providing services can be simplified. This makes it possible to keep the servicing costs low and also to upgrade the contents of services with ease in response to environmental change of service market etc.

Also, since the content for providing services can be transferred efficiently, updating of information for providing services is greatly simplified, making it possible to keep the server operation costs low.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A service execution method comprising:
receiving a service request from a user;
obtaining load information of a server device corresponding to the service request from a device for managing the load information of the server device; and
requesting another server device to process the service request if it is judged that a load on the server device included in the load information is higher than a predetermined value.

2. The service execution method according to claim 1, further comprising:
obtaining load information of the other server device from a device for managing the load information of the other server device; and
sending a process delay notification to the user if it is judged that a load on the other server device is higher than the predetermined value.

3. The service execution method according to claim 1, further comprising:
adding the service request with respect to which the process delay notification is sent, to an end of a queue for holding service requests with respect to which the process delay notification is sent; and
processing a service request at head of the queue by the server device if it is judged that the load information of the server device obtained from the device for managing the load information is lower than the predetermined value.

4. The service execution method according to claim 3, wherein the service request is processed by sending mail to the user.

5. A service execution method comprising:
extracting privilege information from a content privilege information file storing privilege information on content;
extracting information on a user from a user information file storing information about users who use services;
extracting a standard operation sequence from a basic service database storing standard operation sequences for executing the services;
extracting a modification rule from a basic operation modification rule database storing rules for modifying the standard operation sequences; and
modifying the standard operation sequence by applying the modification rule thereto with reference to the content privilege information and the user information, to obtain a operation sequence matching the user.

6. A service execution method comprising:
extracting information on content related to a service requested by a user, from a content file storing the content; and
operating the information on the content in accordance with a operation sequence matching the user.

7. The service execution method according to claim 6, wherein user information includes a bonus point reflecting preference or usage of the user.

8. A service execution method comprising:
obtaining an attribute of a client device used by a user, from first storing means storing client devices and attributes thereof in association with each other;
obtaining a model corresponding to the client device used by the user with use of the attribute of the client device of the user, from second storing means storing attributes of client devices and models corresponding thereto; and
modifying a service obtained in compliance with a request from the user according to the model and sending the modified service to the user.

9. The service execution method according to claim 8, wherein if the second storing means does not store a model corresponding to the client device, the service is modified using a model corresponding to a standard device.

10. A service execution method comprising:
periodically acquiring from an information provider content which is used to provide a service; and
updating the acquired content and storing the updated content in a content storage device.

11. The service execution method according to claim 10, wherein the content storage device is checked to detect damaged content, and if damaged content is detected, the information provider is requested to retransmit corresponding content.

12. The service execution method according to claim 10, wherein the content is acquired through a network.

13. A service execution method comprising:
creating content used to provide a service and storing the created content in an original content storage device; and
acquiring the content from the original content storage device and periodically transmitting the acquired content to a service supplier.

14. A service execution method comprising:
making a service request to a service supplier by using a client device; and
acquiring load information of a server device corresponding to the service request from a device by means of which the service supplier manages the load information of the server device, and if it is judged that a load on the server device included in the load information is higher than a predetermined value, receiving by means of the client device a result of processing by another server device.

15. The service execution method according to claim 14, further comprising:
acquiring load information of the other server device from a device by means of which the service supplier manages the load information of the other server device, and if it is judged that a load on the other server device is higher than the predetermined value, receiving a process delay notification by means of the client device.

16. The service execution method according to claim 14, further comprising:
adding the service request with respect to which the process delay notification is sent, to an end of a queue for holding service requests with respect to which the process delay notification is sent, and if it is judged that the load information of the server device obtained from the device for managing the load information is lower than the predetermined value, receiving by means of the client device a result of processing of a service request at head of the queue by the server device.

17. The service execution method according to claim 16, wherein a user receives the result of processing of the service request by mail transmitted to the client device.

18. A service execution apparatus comprising:
means for receiving a service request from a user;
means for obtaining load information of a server device for processing the service request;
means for determining whether or not a load on the server device included in the load information is higher than a predetermined value; and
means for requesting another server device to process the service request if it is judged that the load on the server device is higher than the predetermined value.

19. The service execution apparatus according to claim 18, further comprising:
means for obtaining load information of the other server device; and
means for determining whether or not a load on the other server device included in the load information of the other server device is higher than the predetermined value.

20. The service execution apparatus according to claim 19, further comprising:
means for sending a process delay notification to the user if it is judged that the loads on both the server device and the other server device are higher than the predetermined value.

21. The service execution apparatus according to claim 20, further comprising:
a queue for holding service requests with respect to which the process delay notification is sent, and
queue creating means for adding to the queue the service request with respect to which the process delay notification is sent.

22. The service execution apparatus according to claim 18, wherein the server device and the other server device include respective content storage devices for storing content corresponding to the service request from the user, said content storage devices including means for holding identical content synchronized with each other.

23. The service execution apparatus according to claim 22, wherein the content is synchronized by transmitting/receiving a difference in updated content.

24. A service execution apparatus comprising:
a content privilege information extracting device for extracting privilege information from a content privilege information file storing privilege information on content;
a user information extracting device for extracting information on a user from a user information file storing information about users who use services;
a basic service database for storing standard operation sequences for executing the services;
a basic operation modification rule database for storing rules for modifying the standard operation sequences; and
a user-oriented operation generating device for modifying a standard operation sequence for executing a service stored in the basic service database, by applying thereto a rule obtained from the basic operation modification rule database with reference to the content privilege information supplied from the content privilege information extracting device and the user information supplied from the user information extracting device.

25. The service execution apparatus according to claim 24, further comprising:
a content information extracting device for extracting information on content related to a service requested by the user, from a content file storing the content,
wherein the content obtained from the content information extracting device is serviced in accordance with a operation supplied from the user-oriented operation generating device.

26. The service execution apparatus according to claim 24, wherein the user information includes a bonus point reflecting preference or usage of the user.

27. A service execution apparatus comprising:
first storing means for storing client devices and attributes thereof in association with each other;
first acquiring means, responsive to use of a client device by a user, for acquiring from the first storing means an attribute corresponding to the client device used by the user;
second storing means for storing models corresponding to the client devices in association with the respective attributes of the client devices;
second acquiring means for acquiring from the second storing means a model corresponding to the client device of the user; and
a result generating device for obtaining the attribute of the client device from the first acquiring means and the model corresponding to the client device from the second acquiring means, and modifying a service obtained in compliance with a request from the user so as to match the client device.

28. The service execution apparatus according to claim 27, wherein if the second storing means does not store a model corresponding to the client device, the service is modified using a model corresponding to a standard device.

29. A service execution apparatus comprising:
means for periodically acquiring from an information provider content which is used to provide a service; and
content storing means for updating the acquired content and storing the updated content.

30. The service execution apparatus according to claim 29, wherein the content is deleted from the content storing means in accordance with a delete instruction from the information provider.

31. The service execution apparatus according to claim 29, further comprising:
a content checking device for checking the content storing means to detect damaged content, and wherein if damaged content is detected, the content checking device requests the information provider to retransmit corresponding content.

32. The service execution apparatus according to claim 29, wherein the content is acquired through a network.

33. A service execution apparatus comprising:
means for creating content used to provide a service;
original content storing means for storing the created content; and
means for acquiring the content from the original content storing means and periodically transmitting the acquired content to a service supplier.
